(19) United States
(12) Patent Application Publication
(10) Pub. No.: US 2013/0189654 A1
(43) Pub. Date: Jul. 25, 2013

(54) VOCABULARY LEARNING SYSTEM AND METHOD

(71) Applicant: Adjelia Learning, Inc., Concord, NH (US)

(72) Inventors: Chandler W. Symmes, Concord, NH (US); Phil Wallingford, Concord, NH (US)

(73) Assignee: Adjelia Learning, Inc., Concord, NH (US)

(21) Appl. No.: 13/742,448

(22) Filed: Jan. 16, 2013

Related U.S. Application Data
(60) Provisional application No. 61/586,958, filed on Jan. 16, 2012.

(51) Int. Cl. G09B 17/00

(52) U.S. Cl. CPC G09B 17/006
USPC 434/169

(57) ABSTRACT

A computerized system and method of teaching vocabulary to a student includes an application that provides predetermined word lists. A teacher or instructor may also add words to the word database based on a user's curriculum, cross-curriculum or words of interest. The words in the word database are utilized to automatically create an individualized vocabulary assignment. The user is instructed to learn the new vocabulary words by breaking the words into their suffixes, prefixes, roots and word origin and history. The student is encouraged to create a word history or etymology of the word to understand the history, the language of origin, and the language from which the word is borrowed. The student is then instructed to use the vocabulary word(s) in a sentence. The teacher, instructor or an online tutor monitors the completion of the various assignments by the student and also monitors how well the assignments are performed.

### CROSS-REFERENCE TO RELATED APPLICATIONS

This application claims priority from U.S. Provisional Patent Application No. 61/586,958 entitled “Vocabulary Learning System And Method”, filed on Jan. 16, 2012 of which is incorporated fully herein by reference.

### TECHNICAL FIELD

The present invention relates to teaching systems and more particularly, to a system and method that is designed to capture words from sentences, to breakdown or deconstruct the words into prefixes, roots and suffixes and then use these fragments as part of a comprehensive teaching tool.

### BACKGROUND INFORMATION

Various computer-based vocabulary programs exist and are well known in the art. These programs work in conjunction with various computer-based devices and programs such as word processors, e-mail programs, web page generation programs and the like, to provide vocabulary assistance, such as definitions, meanings of prefixes, roots and suffixes, and word origins. Each of these existing products looks at one particular word at a time and focus on one type of assistance. The programs do not make comparisons among similar words or enable a student to make connections among the meanings of various suffixes, roots and prefixes.

Excellent vocabulary knowledge can translate into excellent scores on critical learning tests, such as the SAT. A thorough understanding of suffixes, roots and prefixes achieved through an understanding and study of high-frequency roots, when started early and practiced frequently, will give a student the skills to tackle difficult vocabulary assignments.

In order to excel in vocabulary testing, a student must consider related roots, prefixes and suffixes. This involves both using context clues to determine the meaning of a word, but also includes having a subtle knowledge of Greek and Latin roots. A student must be comfortable taking apart a word into its parts to investigate all potential meanings. This can involve understanding the word's history and origin and knowing the subtleties surrounding when the word joined the language in order to understand different connotations. A student may also need to be able to determine the meaning of a word when there is little or no supporting context. This can best be accomplished when a student knows the structure of the word and is familiar with the process of word investigation.

Students need to be able to use clear, precise and appropriate vocabulary in many contexts throughout their education and professional lives. Ideally, everyone should be able to master a broad and extensive vocabulary that they are able to access in a wide variety of syntactical structures and contexts. This practice involves recognizing the correct use of complex syntax, the ability to vary sentence structure and to apply conclusions drawn from a text to another context. These types of critical thinking exercises are essential for standardized tests as well as many professional and personal endeavors.

An additional problem with the prior art computer based learning tools is that the programs are hardware dependent and must be downloaded and installed, creating issues such as operating system requirements, hard-drive capacity, minimum ram requirements, availability of IT support, high implementation costs for users such as school and school districts, etc.

There has not, to date, been a product that is designed to accomplish all of these goals and to provide a student with a comprehensive vocabulary teaching tool. Accordingly, what is needed is a program that is designed to offer students a method of learning high-frequency roots, starting at an early age, which is practiced frequently in order to gain the knowledge necessary to handle difficult vocabulary. The program should encourage students to be mentally active readers, to deeply process the words and their meanings, to know when the word originated and from where the word originated using historical context. The program should not just teach vocabulary, but should provide students with knowledge of the internal structure of words, a clear, precise and appropriate vocabulary; access to an extensive vocabulary across syntactic contexts; the ability to recognize and use complex and varied syntax; and creative, interdisciplinary thinking abilities.

### SUMMARY

The present invention provides a system and method of teaching vocabulary and reading comprehension that involves the use of historical context and critical thinking to break down a word into its prefix, suffix and root.

### BRIEF DESCRIPTION OF THE DRAWINGS

These and other features and advantages of the present invention will be better understood by reading the following detailed description, taken together with the drawings wherein:

FIG. 1 is a block diagram of a system on which may be implemented the present invention according to one aspect of the present invention;

FIG. 2 is a block diagram of how words are funneled into the word database and ultimately an individual's vocabulary lesson plan according to one feature of the present invention;

FIG. 3 is a representation of an individual's vocabulary assignments/lessons provided by the system and method according to one aspect of the present invention;

FIG. 4 is a block diagram of the functions or actions which a student takes in using the present invention;

FIG. 5 is a flow chart illustrating the functions or actions which a teacher takes in using the system and method according to the present invention;

FIG. 6 is a representation of exemplary teacher functions to be selected from the system and method of the present invention; and

FIG. 7 is an example of a list of words from a predetermined word category or program list.

### DETAILED DESCRIPTION OF THE PREFERRED EMBODIMENTS

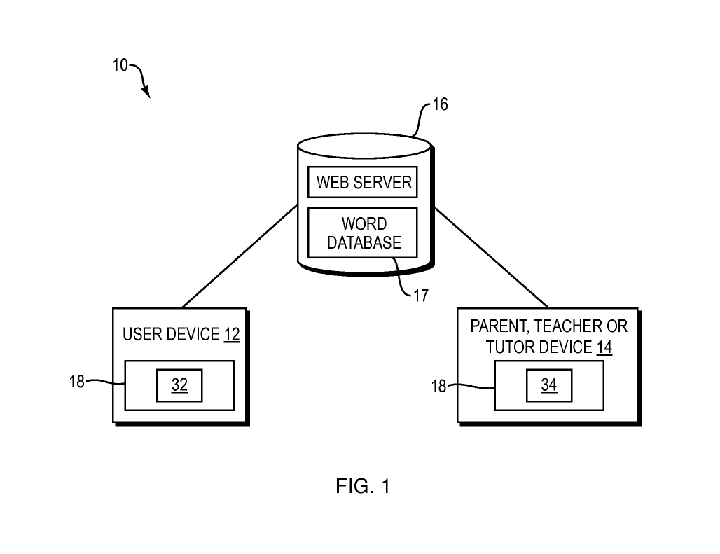

The system 10, FIG. 1, according to the present invention, provides a comprehensive vocabulary teaching tool. The system 10 includes, in a first preferred embodiment, one or more components that are hosted on the server. In fact, the universal access via the web is a key advantage. The program is hardware agnostic, download and installation free. This breaks down common barriers to computer learning tools such as operating system requirements, hard-drive capacity, minimum ram, availability of IT support, etc. and reduces implementation costs for schools and districts. The invention delivers differentiated instruction that would otherwise be cost-prohibitive. The program works on all computers and tablets. There is no download or installation required, and students can log in from home, reducing demands on school computers and IT staff. And of course, there is no paper and no printing required.

In a second embodiment, the invention may be implemented as a smart phone or tablet application (app) that would be downloaded/installed onto a user's electronic device 12 (such as, but not limited to a personal computer (PC), notebook computer, Ipad, smartphone or the like), and an optional complimentary component or components loaded onto the same or a second electronic device 14 which may be used by a parent, teacher, tutor or other entity to assist in the teaching of vocabulary to a user.

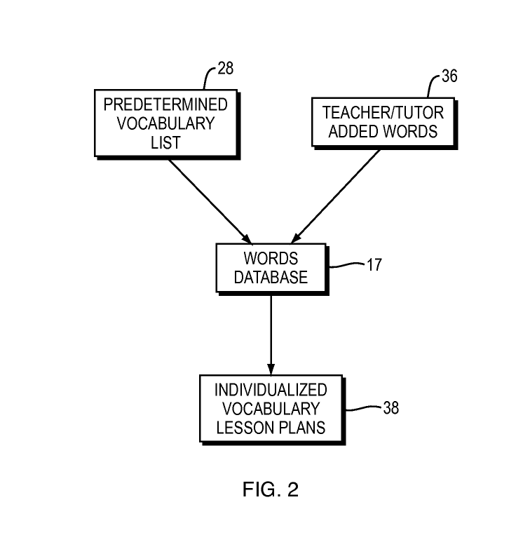

The present invention includes a Web server 16 which serves to store a words database 17, and to present the words to one or more applications 32/34 running on a Web browser 18 of PC 12 or 14. The words database 17 is posted on the Web server 16 and provides each school, classroom or organization with its own unique database. Each words database 17 is a complete record of each student's vocabulary lessons organized by session and date, teacher and class. The database 17, FIG. 2, may include a predetermined vocabulary list 28, FIG. 2, that is managed by the database 17 and organized by class and associated with weekly dates. As students work through the vocabulary instruction, practice and test activities, the students are reviewed and retested at specified intervals. The teacher, tutor or other instructor can also add additional teacher/tutor words 36 to the words database 17. The individualized vocabulary lesson plans 38 are created from the words database 17.

This critical approach to word study allows each student to proceed at their own pace and on their own level. Within a structured, teacher-directed lesson, a student discovers word structure, meaning and origin on their own, thereby engaging the student in the process of critical thinking. The system guides the student through this critical endeavor step-by-step. Each student learns how words work, by compelling a student to look inside language and to deconstruct words by sound and by meaning, thereby understanding how the word was formed. This critical thinking approach involves investigating the age of words and the history behind where the words came from. In searching for borrowings, students practice metalinguistic knowledge, which is a key literacy element. The program also allows students to apply the knowledge in writing. The program offers repeated rounds of practice with word-level tasks.

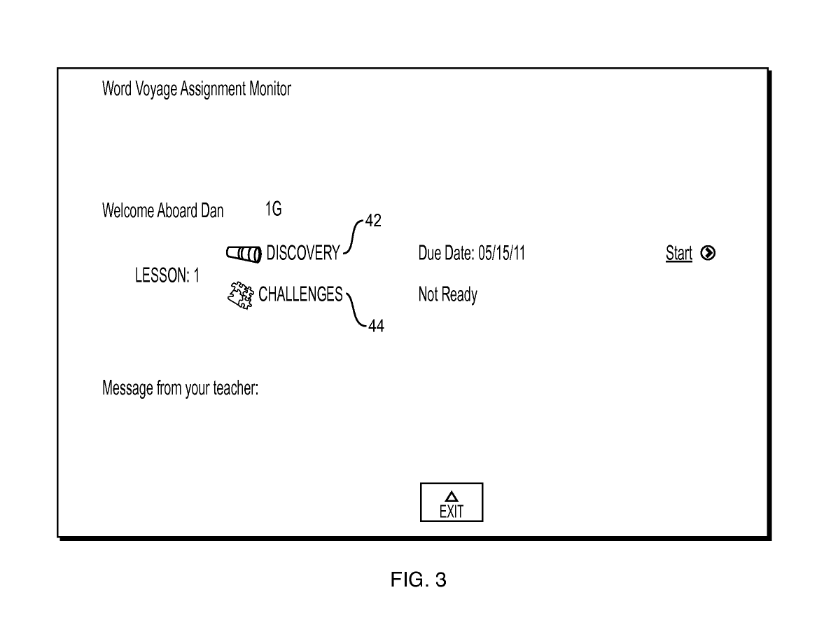

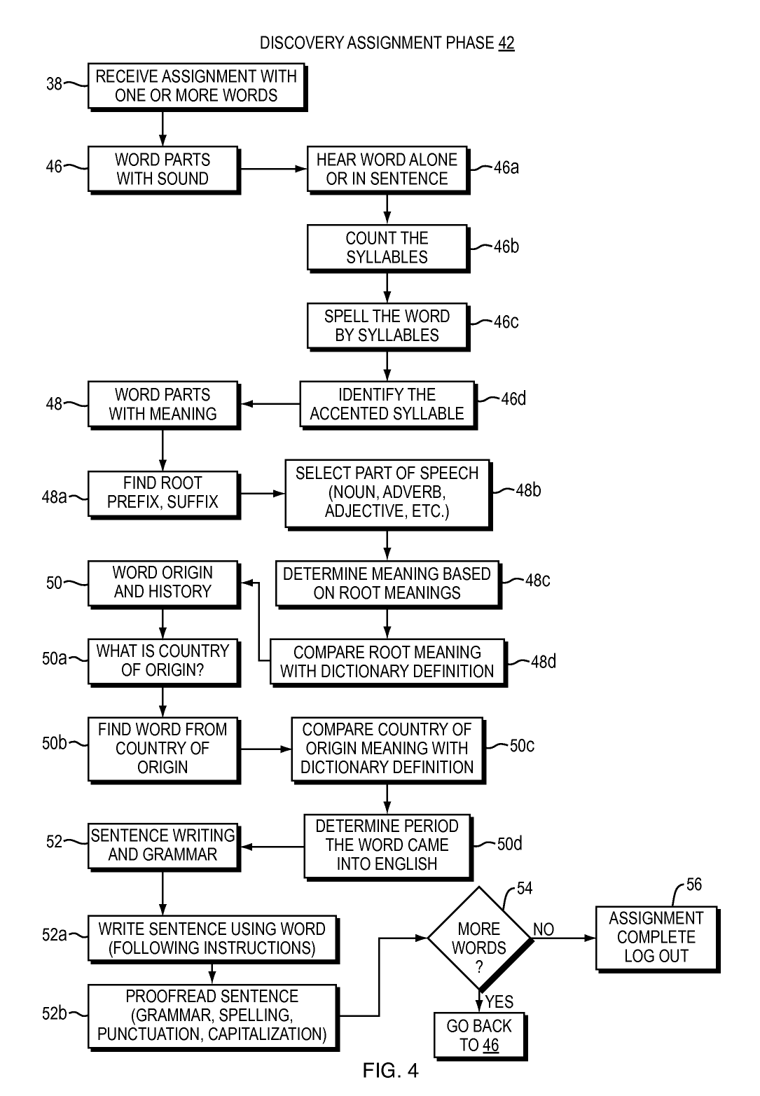

The lessons are divided into two sections: discovery 42 and challenge 44, FIG. 3. The discovery section 42, FIG. 4, asks the student to engage each word in four ways: word parts with sound 46, word parts with meaning 48, word origin/history 50 and sentence writing 52. Each student is provided with one or more assignments 38 that contain one or more vocabulary words. Word parts with sound 46 assignment requires the student to listen to the word (given either as an individual word or in a sentence) 46a and to count the syllables 46b, to then spell the word by syllable 46c and then to select the accented syllable 46d. “Authentic” words or authentitic spelling errors, (means actual words used and/or misspelled words generated by a user during normal day-to-day writing) captured from the student's own writing, may also be practiced in this section. For some words, a “Spelling Tip” button will play a dictated spelling rule to offer the student additional spelling support.

The word parts with meaning 48 assignment requires the student to determine the prefix, base root and suffix 48a of each word. The prompt will vary depending on the word and the presence of the various word portions. For example, if the word does not have a prefix, then the application will not prompt for a prefix. Each prefix, root and suffix is selected from a menu of various options. Each prefix, suffix and root is defined in the menu. The student will then be prompted to select the part of speech 48b, such as whether the word is a noun, adjective, verb, pronoun, etc. Then the student will be asked to organize the root meanings into the word meaning up from the roots 48c. This involves taking the individual roots, prefixes and suffixes and their associated definitions and organizing them into an order that best represents the cohesive definition of the word. Then the student is asked to compare this root definition with the dictionary definition 48d.

The word origins and history assignment 50 teaches the student the country of origin of the word 50a, and then prompts the student to find the word from the country of origin 50b as the word was originally used in that country. This involves finding the foreign source-word. The student is prompted to look up the foreign word in a dictionary to find the meaning of the foreign word and to then compare that foreign word definition with the dictionary definition 50c. Finally, the student is asked to determine the period that the word came into English 50d.

The sentence writing and grammar assignment 52 requires the student to first listen to, and transcribe, a dictated sample sentence that demonstrates a proper usage of the vocabulary word. Next, the student is asked to rewrite the sample sentence replacing the vocabulary word with a synonym word or phrase, retaining the same overall meaning of the sample sentence. Lastly, the student is asked to write the vocabulary word in an original sentence as assigned by the teacher 52a. The teacher can provide various instructions to the sentence writing portion, such as requiring a minimum number of words, or requiring various punctuation to be used in the sentence. The program will screen the sentence for certain errors, for example but not limited to capitalization, punctuation, and minimum required words. Then the student is prompted to proofread the sentence 52b. The act of proofreading the sentence may require that the student review the sentence for proper spelling, grammar, punctuation, capitalization, etc. The sentence is then passed into the teacher. The teacher may accept or return it for revision, with or without comment. The student can then revise the sentence as required by the teacher.

Once the instructions have been completed for a first word, the system 10 will determine if there are more words 54 to be similarly worked through. If there are more words, the system will go back to the first act, word parts with sound 46, and continue through the acts of FIG. 4. If there are no more words in the vocabulary lesson plan 38, then the discovery assignment 42 is complete 56.

The second assignment section is the challenge section 44, which quizzes the student on this content. The challenge section 44 can test the student on one or more individual predetermined vocabulary lists 28 or teacher/tutor added words 36. The challenge section may include all of the vocabulary lesson plans 38 learned by a student in a given day, week, month or year.

Each word can be connected with a story. This story is the etymology of the particular word. The story may include how old the word is, which languages the word passed through on its way to English, what the word's ethnicity is, the characteristics that the word shares with other words, and more. Whenever a student is confronted with an unfamiliar word, they are encouraged to discover and learn the back story of the word. By connecting each word with a back story, there is a higher probability that the meaning and spelling of the word will be remembered.

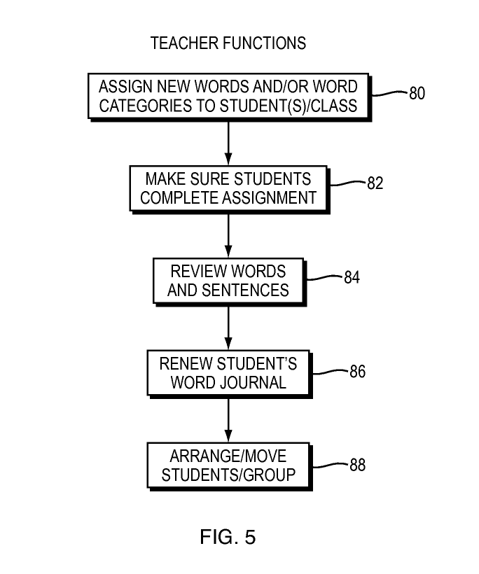

The system 10 provides all necessary reference materials, which may include video materials. The reference materials teach the students about syllables, word roots, root meanings, parts of speech, borrowings, and periods of English. The system 10 allows one teacher to facilitate instruction for 100 or more students. The teacher is provided with various teacher functions, FIG. 5, shown on an interface on their PC or other electronic device 14, which allows the teacher to customize the assignments for and track progress of each individual student. The teacher can assign new words and/or word categories to student(s)/class(es) 80. The teacher can track each student's progress and ensure that students complete assignments 82. The teacher can review words and sentences 84 completed by each student. The system 10 also allows a teacher to review a student's word journal 86 and create challenges or new lessons from the word journal. The teacher can arrange or move students or groups 88 into level-appropriate default settings, word-lists and writing assignments. Each group or setting can be customized and established through a simple process. Students can be moved from group to group at any time and groups can be of any size.

Each lesson can include one or more of the four discovery sections defined above. The teacher can set the lesson scope via the ability to turn each one of these four discovery sections on or off, thereby personalizing the study for each group, and allowing students to focus only on the activities that are activated. The teacher can also set the lesson size, the due dates, the scoring parameters, and the creation of automatic lessons, which enables lessons to be sent automatically to a particular group without the need for recurring teacher input.

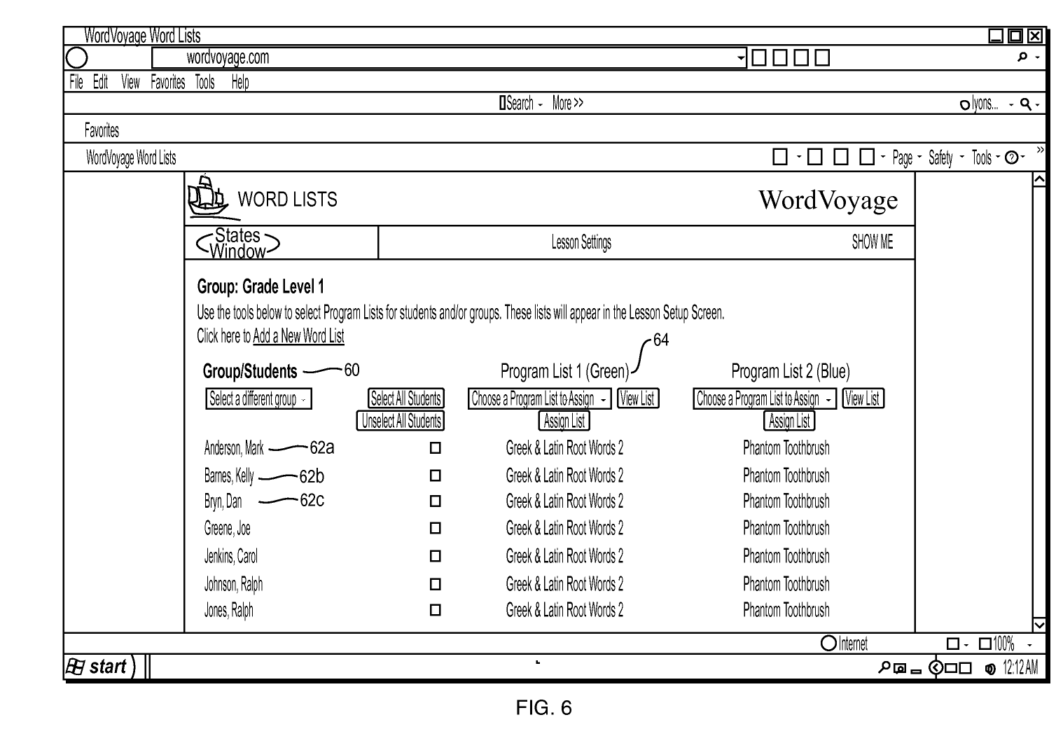

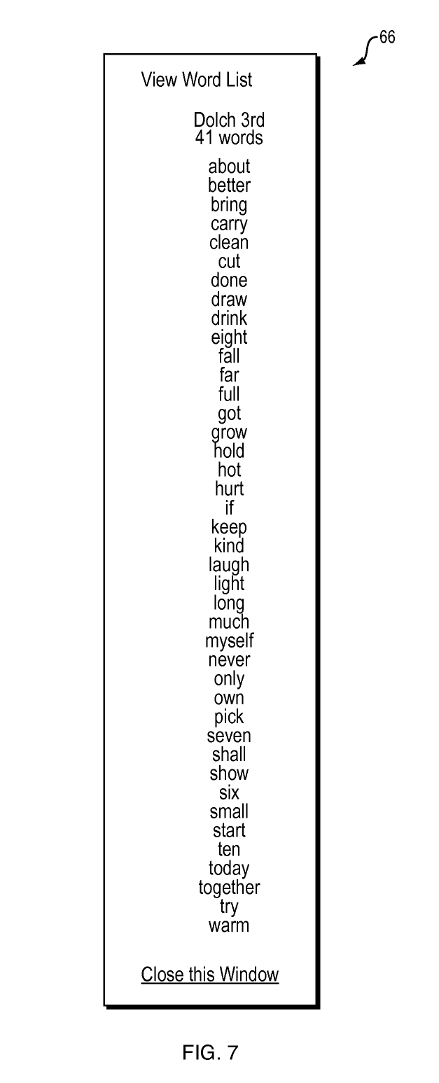

Teachers are provided with a multitude of tools to customize lessons based on the age and progress of each group. FIG. 6 includes a screenshot of a sample group of students 60. Each student 62 (a, b, c, etc.) has at least one lesson plan or program list 64, which includes a program list of words 66 (FIG. 7) as assigned by the teacher. For example, there are various program lists 64 for Greek and Latin root words and for SAT/ACT test preparation, as well as program lists based on various novels and fields of study. Additionally, there is an origins section that includes words from various origins such as, French, German, Italian, Arabic, Old English, Latin, Greek, Dutch, Hindi, Old Norse, Sanskrit, and Spanish. The tools can be customized and can be periodically updated with new words, new lists, or additional testing materials.

The system 10 also includes a sentence writing feature that provides assignments to each group. These assignments break down each word into the type (Declarative/Imperative/Exclamatory/Interrogative), the structure (Simple/Compound/Complex/Compound-Complex), and the number of parts (1-4) and can include teacher composed directions. Teachers also have the ability to utilize additional tools to individualize lessons beyond the differentiation offered by the group settings. Some of these additional tools include the ability to create captured words, which are spelling errors from the student's own writing, which can be added to the lessons. The ability to use recycled words, which come from a journal for each student that contains all previously studied words. The teacher can used the journal, which is sortable, to track recurring errors and re-assign words for additional practice. The teacher can provide feedback for student sentences, which enables a teacher to return unacceptable sentences to students with the option of including comments. Comments which are used frequently can be saved for repeated use. Additionally, the system includes lesson plans for classroom activities that support the program.

The system 10 is preferably completely web-based and compatible with various operating systems including, but not limited to Windows, Mac and Linux. The system 10 is supported on browsers such as Internet Explorer, Firefox, Chrome and Safari. The system 10 does not require the use of additional software, such as Flash Player from Adobe or another similar program. The system 10 allows teachers and students to self-register and for each student to be managed by a teacher. Students can be transferred from one teacher to another as they move from grade to grade or as needed. The system may also include user friendly features for students, such as a first time user tour video, an on-screen character that can assist students by addressing them by name, explaining exercises and providing feedback.

The system may also include user friendly features for teachers, such as a first time user tour video, videos that demonstrate the operations of each page, phone and email support, a blog and forum for posting questions and networking with other teachers, web meetings that offer web-based training in program operations and academic content and on-site training where trainers would visit schools or other locations to offer face-to-face training services. The system also provides extensive reports on student performance. Tools are provided to easily transfer students between teachers or grades. Transferred students come with all performance data and journal entries accumulated under the previous teacher. In this way, each student's individual skill deficiencies can easily be tracked, identified, and addressed as the student advances through the grades.

In another embodiment of the present invention, the system offers a virtual tutor. This embodiment is ideal for home schooling or other situations where a teacher needs additional oversight of the lesson planning. An individualized lesson is administered over the web by a tutor. Lessons can be continually adjusted based on student performance. The tutor can assess the student's level and focus the lesson on skills needing reinforcement or improvement and as progress is achieved, the tutor can expand the difficulty of the lessons. Progress is tracked and then reported to parents and/or teachers on a regular basis, such as quarterly.

Accordingly, the present invention provides a system that actively engages students in vocabulary lessons. The system encourages students to break down words into their roots and to discover the meaning of the words based on these parts as well as the surrounding context. The system leads to better word comprehension through high frequency Greek and Latin roots and the repetitive practice of braking down the words to discover their meaning.

It is important to note that the present invention is not intended to be limited to a device or method which must satisfy one or more of any stated or implied objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claim:

1. A method for providing an individualized vocabulary assignment containing words to be taught to a user using an automated computer program, the method comprising:
receiving, by a user on a computerized device and from a vocabulary computer software program operating on an electronic system, one or more vocabulary words to be studied by the user;
responsive to said received one or more vocabulary words, automatically creating at least one computerized individualized teaching assignment, accessed by said user utilizing a user computer system, said computerized individualized teaching assignment including requiring said user to deconstruct said one or more vocabulary words into one or more of the following: prefixes, suffixes, roots, word origin and history;
instructing said user to use the one or more vocabulary words in a sentence; and
monitoring said user performance on said at least one computerized individualized teaching assignment and said user use of the one or more vocabulary words in a sentence by a teacher, instructor or an online tutor, said monitoring for determining one or more of the completion of the various assignments by the student and how well the assignments are performed.

2. The method of claim 1 wherein said one or more vocabulary words are authentic vocabulary words used by said user during normal day-to-day writing.

3. The method of claim 2 wherein said authentic vocabulary words include actual words used and/or misspelled words generated by said user during normal day-to-day writing.

4. The method of claim 1 wherein said electronic system on which said vocabulary computer software program operates is a web server and is user hardware agnostic.
